(19) United States
(12) Patent Application Publication
(10) Pub. No.: US 2025/0199500 A1
(43) Pub. Date: Jun. 19, 2025

(54) NUMERICAL CONTROL DEVICE

(71) Applicant: FANUC CORPORATION, Minamitsuru-gun, Yamanashi (JP)

(72) Inventors: Jun YAGI, Yamanashi (JP); Ryuutarou NISHIMURA, Yamanashi (JP)

(21) Appl. No.: 18/690,440

(22) PCT Filed: Oct. 6, 2021
(86) PCT No.: PCT/JP2021/036983

§ 371 Date: Oct. 2, 2024

(51) Int. Cl. G05B 19/19

(52) U.S. Cl. CPC G05B 19/19; G05B 2219/34083; G05B 2219/42173

(57) ABSTRACT

The present invention realizes deceleration without deviation with respect to a corner speed while maintaining behavior during deceleration at a constant level. This numerical control device comprises: a remaining movement amount calculation unit for calculating a remaining movement amount of a block in a machining program; an excess movement amount calculation unit for calculating, as an excess movement amount, a difference between the remaining movement amount of the block and a movement amount required for deceleration from a present command speed to a corner speed at a designated acceleration; an adjustment amount calculation unit for calculating an acceleration adjustment amount, at the start of the deceleration, for using the entirety of the excess movement amount at interpolation times, on the basis of the excess movement amount, the present command speed, the corner speed, and the designated acceleration; an acceleration calculation unit for calculating a first acceleration obtained by adjusting the acceleration designated at the start of the deceleration using the acceleration adjustment amount and a second acceleration for deceleration to the corner speed at the remaining interpolation times; and a pre-interpolation acceleration/deceleration processing unit for designating the first acceleration at the start of the deceleration and designating the second acceleration at the remaining interpolation times.

### TECHNICAL FIELD

The present invention relates to a numerical control device.

### BACKGROUND ART

A numerical control device controls operation of a machine tool by dividing a movement amount for each block of a machining program by a movement amount for each interpolation cycle and performing interpolation. At that time, when a movement amount of one block is divided by the movement amount for each interpolation cycle, an excess movement amount may occur.

In this regard, there is known a technology for preventing occurrence of the excess movement amount by, while deceleration is performed at a set constant acceleration, temporarily discontinuing the deceleration at the acceleration. See, for example, Patent Document 1.

Further, there is known a technology for preventing occurrence of the excess movement amount by performing deceleration at an acceleration obtained by adjusting a constant acceleration set in advance in the first interpolation cycle at the time of starting the deceleration and then performing deceleration at the constant acceleration in the remaining interpolation cycles. See, for example, Patent Document 2.

### CITATION LIST

### Patent Document

Patent Document 1: Japanese Unexamined Patent Application, Publication No. H6-289922
Patent Document 2: Japanese Unexamined Patent Application, Publication No. 2001-92518

### DISCLOSURE OF THE INVENTION

### Problems to be Solved by the Invention

FIG. 5 is a diagram showing an example of deceleration processing in Patent Document 1. FIG. 6 is a diagram showing an example of deceleration processing in Patent Document 2. As shown in FIG. 5, for example, even if an ideal timing (indicated by a broken line) to perform deceleration from a command speed V to a corner speed Vc is between time ta and time tb, actual deceleration (indicated by a long dashed and short dashed line) is started at the time ta which is a timing of an interpolation cycle. Therefore, in Patent Document 1, in order to prevent occurrence of a difference between the actual deceleration and the ideal deceleration, that is, the excess movement amount, deceleration, for example, at time td_is temporarily discontinued. However, since deceleration torque fluctuates during deceleration due to the temporary discontinuation of deceleration, there is a problem that vibration of the drive system of a machine tool is caused.

In Patent Document 2, as shown in FIG. 6, the excess movement amount is used by performing deceleration at the acceleration obtained by adjusting the constant acceleration set in advance, in the first interpolation cycle at the time of starting the deceleration, and, in the subsequent interpolation cycles, increasing the speed for all the interpolations during deceleration in comparison with the case of FIG. 5. Thereby, since the temporary discontinuation of deceleration does not occur, the vibration of the mechanical drive system is prevented. There is, however, a problem that a deviation with respect to the corner speed Vc corresponding to the amount of adjustment occurs at time tf of the final interpolation cycle. Since the deviation varies, it is difficult to adjust the machine tool. A broken line in FIG. 6 indicates the deceleration profile of Patent Document 1 in FIG. 5.

Therefore, it is desired to perform deceleration without a deviation with respect to a corner speed while keeping behavior during the deceleration constant.

### Means for Solving the Problems

One aspect of a numerical control device of the present disclosure includes: a remaining movement amount calculation unit configured to calculate a remaining movement amount of a block included in a machining program; an excess movement amount calculation unit configured to calculate, as an excess movement amount, a difference between the remaining movement amount of the block and a movement amount required to perform deceleration from a present command speed to a corner speed at a designated acceleration; an adjustment amount calculation unit configured to calculate, based on the excess movement amount, the present command speed, the corner speed, and the designated acceleration, an acceleration adjustment amount at time of starting the deceleration, for using all the excess movement amount with the number of interpolations in a deceleration section for performing the deceleration from the present command speed to the corner speed; an acceleration calculation unit configured to calculate a first acceleration obtained by adjusting the designated acceleration with the acceleration adjustment amount, for decelerating the present command speed at the time of starting the deceleration, and calculate a second acceleration for performing deceleration from the command speed that has been decelerated at the first acceleration to the corner speed with the remaining number of interpolations; and a pre-interpolation acceleration/deceleration processing unit configured to designate the first acceleration at the time of starting the deceleration and designate the second acceleration for the remaining number of interpolations.

### Effects of the Invention

According to one aspect, it is possible to perform deceleration without a deviation with respect to a corner speed while keeping behavior during the deceleration constant.

### BRIEF DESCRIPTION OF THE DRAWINGS

FIG. 1 is a functional block diagram showing a functional configuration example of a numerical control device according to one embodiment;

FIG. 2 is a diagram showing an example of a relationship between interpolation cycles and a command speed;

FIG. 3 is a diagram showing an example of explanation of operation of an adjustment amount calculation unit;

FIG. 4 is a flowchart illustrating an acceleration correction process of the numerical control device;

FIG. 5 is a diagram showing an example of deceleration processing in Patent Document 1; and

FIG. 6 is a diagram showing an example of deceleration processing in Patent Document 2.

### PREFERRED MODE FOR CARRYING OUT THE INVENTION

A specific embodiment of a numerical control device will be described, with a case of decelerating a drive portion of a machine tool, such as a servo axis, as an exemplification. The present invention is not limited to the case of decelerating the drive portion but is also applicable to a case of accelerating the drive portion.

### One Embodiment

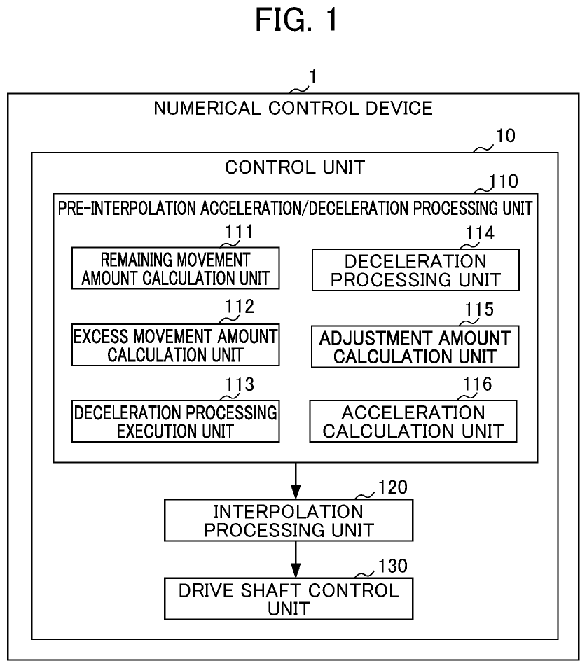

FIG. 1 is a functional block diagram showing a functional configuration example of a numerical control device according to one embodiment.

A numerical control device 1 is a numerical control device well known to one skilled_in the art and may be directly connected to a machine tool not shown via a connection interface not shown. Further, the numerical control device 1 may be connected to the machine tool not shown via a network not shown such as a LAN (local area network) or the Internet. In this case, the numerical control device 1 may be provided with a communication unit not shown for communicating with the machine tool not shown via such connection.

The numerical control device 1 generates an operation instruction based on a machining program acquired, for example, from a CAD/CAM apparatus or the like not shown, and transmits the generated operation instruction to the machine tool (not shown). Thereby, the numerical control device 1 controls operation of the machine tool not shown. When the machine tool not shown is a robot or the like, the numerical control device 1 may be a robot control device or the like.

As shown in FIG. 1, the numerical control device 1 includes a control unit 10. The control unit 10 includes a pre-interpolation acceleration/deceleration processing unit 110, an interpolation processing unit 120, and a drive shaft control unit 130. The pre-interpolation acceleration/deceleration processing unit 110 includes a remaining movement amount calculation unit 111, an excess movement amount calculation unit 112, a deceleration processing execution unit 113, a deceleration processing unit 114, an adjustment amount calculation unit 115, and an acceleration calculation unit 116.

The control unit 10 includes a CPU (central processing unit), a ROM (read-only memory), a RAM (random access memory), a CMOS (complementary metal-oxide-semiconductor) memory, and the like, and these are configured to be mutually communicable via a bus and are well known to one skilled_in the art.

The CPU is a processor that performs overall control of the numerical control device 1. The CPU reads out a system program and an application program that are stored_in the ROM and controls the whole numerical control device 1 according to the system program and the application program. Thereby, the control unit 10 is configured to realize the functions of the pre-interpolation acceleration/deceleration processing unit 110, the interpolation processing unit 120, and the drive shaft control unit 130 as shown in FIG. 1. The pre-interpolation acceleration/deceleration processing unit 110 is configured to realize the functions of the remaining movement amount calculation unit 111, the excess movement amount calculation unit 112, the deceleration processing execution unit 113, the deceleration processing unit 114, the adjustment amount calculation unit 115, and the acceleration calculation unit 116. In the RAM, various kinds of data such as temporary calculation data and display data is stored. The CMOS memory is backed up by a battery not shown and_is configured as a nonvolatile memory the storage state of which is maintained even if the power source of the numerical control device 1 is turned off.

The remaining movement amount calculation unit 111 calculates a remaining movement amount of a block included in the machining program.

Specifically, for example, in a case where an interpolation cycle T is 1 ms/1 interpolation, and the block is “G01 X100. F6000,” movement of 100 mm in an X axis direction at a speed of 0.1 mm/ms (=6000 mm/min) is performed during 1000 interpolation cycles (1000 T's).

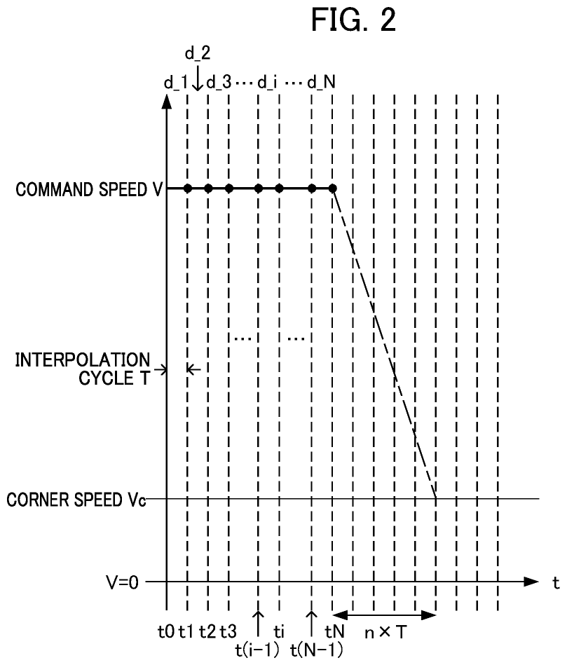

FIG. 2 is a diagram showing an example of a relationship between the interpolation cycles T and a command speed V.

In this case, a movement amount for one block (100 mm) can be indicated by Formula (1).

$$Movement amount for 1 block = d\_ 1 + d\_ 2 + d\_ 3 + … + d\_N \qquad ( 1 )$$

Here, d_1 to d_N indicate movement amounts for the interpolation cycles T, respectively, which are 0.1 mm in the above case. Further, N indicates the last interpolation cycle T, and_N=1000 is assumed in the above case.

Therefore, the remaining movement amount calculation unit 111 calculates a remaining movement amount Dr by adding up movement amounts buffered for the interpolation cycles T, respectively, using Formula (2) (i is an integer equal to or larger than 1).

$$Dr = d\_i + d\_ ( i + 1 ) + d\_ ( i + 2 ) + … + d\_N \qquad ( 2 )$$

Here, d_i indicates a movement amount in the interpolation cycle T of the present block, and d_N indicates a movement amount in the last interpolation cycle of the block. Further, t0 to tN indicate times of interpolation.

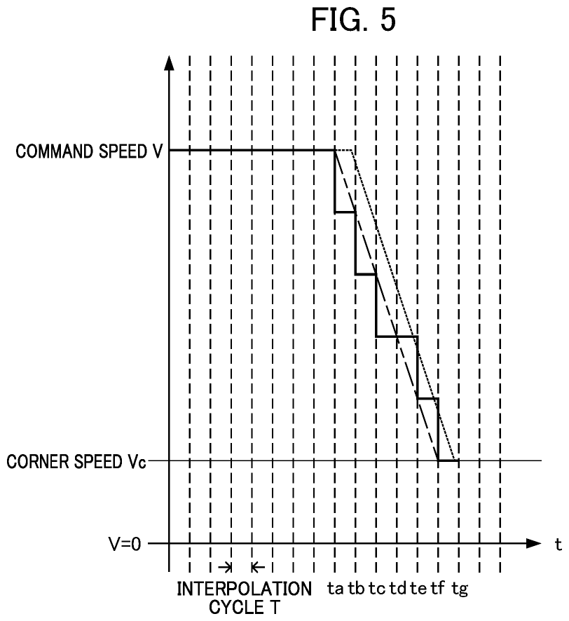

In the description below, a case will be exemplified in which, after the N-th interpolation, the deceleration to the corner speed Vc in a deceleration section with n (for example, five) interpolation cycles T from time tN at a designated acceleration A [mm/ms/ms], which is indicated by the long dashed and short dashed line in FIG. 5, is performed in consideration of impact and the like on the machine tool (not shown) as shown in FIG. 2.

The excess movement amount calculation unit 112 calculates a difference between the remaining movement amount Dr of the block calculated by the remaining movement amount calculation unit 111 and a movement amount required to perform deceleration from the present command speed to the corner speed at the designated acceleration, as a remaining movement amount.

Specifically, the excess movement amount calculation unit 112 calculates a movement amount Dc [mm] required to perform deceleration from the present command speed V [mm/ms] to the corner speed Vc [mm/ms] at the designated acceleration A [mm/ms/ms] using Formula (3).

$$D c = ( V + V c ) \times ( n + 1 ) / 2 \qquad ( 3 )$$

Here, as for the number of interpolations n in the deceleration section, n=(V-Vc)/(A×T) holds.

The excess movement amount calculation unit 112 calculates an excess movement amount Ds [mm] using the remaining movement amount Dr calculated by the remaining movement amount calculation unit 111, the calculated movement amount Dc, and Formula (4).

$$D s = D r - D c \qquad ( 4 )$$

For example, by monitoring a movement amount d for each interpolation cycle T, the deceleration processing execution unit 113 judges whether the excess movement amount Ds calculated by the excess movement amount calculation unit 112 is smaller than the movement amount d for each interpolation cycle or not. If the excess movement amount Ds is smaller than the movement amount d for each interpolation cycle T, the deceleration processing unit 114 described later executes deceleration processing. On the other hand, if the excess movement amount Ds is equal to or larger than the movement amount d for each interpolation cycle, the deceleration processing execution unit 113 maintains the present command speed V.

The deceleration processing unit 114 subtracts an acceleration calculated by the acceleration calculation unit 116 described later from the present command speed V to calculate a speed V′ for the next interpolation cycle.

The adjustment amount calculation unit 115 calculates an acceleration adjustment amount adj at the time of starting deceleration for using all the excess movement amount Ds with the number of interpolations n in the deceleration section for performing deceleration from the present command speed V to the corner speed Vc, based on the excess movement amount Ds, the present command speed V, the corner speed Vc, and the designated acceleration A.

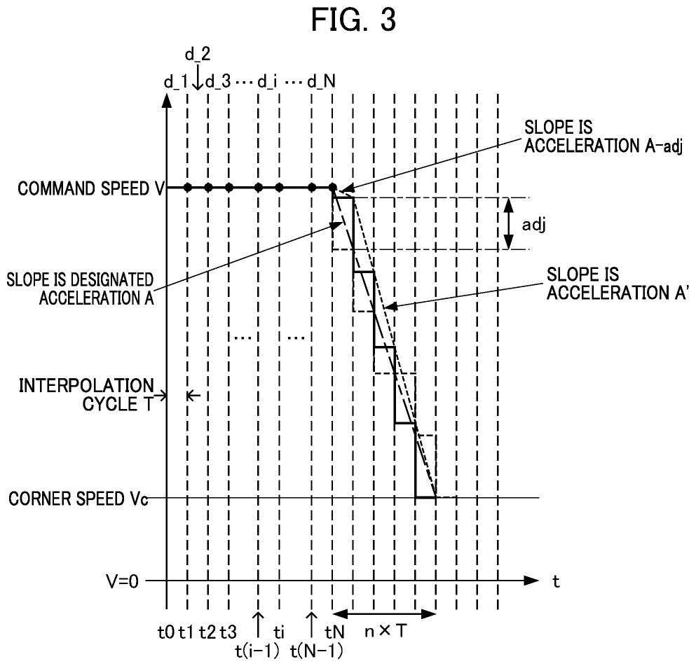

FIG. 3 is a diagram showing an example of explanation of operation of the adjustment amount calculation unit 115. In FIG. 3, deceleration of the command speed V according to the present embodiment is indicated by a solid line, and the deceleration of the command speed V in FIG. 5 is indicated by a broken line. Further, an acceleration (slope) of the command speed V according to the present embodiment is indicated by a broken line, and the acceleration (slope) of the command speed V in FIG. 5 is indicated by a long dashed short dashed line.

In the case of FIG. 3, the deceleration section from the present command speed V to the corner speed Vc is a period from time tN to time tN+n×T with the number of interpolations n.

In this case, as for the acceleration adjustment amount adj in the first interpolation cycle T (from the time tN to the time tN+T) at the time of starting deceleration, Formula (5) is derived from the relationship of Ds=adj×(n−1)/2, which indicates that the excess movement amount Ds is equal to the area of a triangle with the acceleration adjustment amount adj at the time tN+T as the base and the number of interpolations (n−1) between the time tN+T and the time tN+n×T as the height.

$$adj = 2 \times Ds / ( n - 1 ) \qquad ( 5 )$$

The adjustment amount calculation unit 115 calculates the acceleration adjustment amount adj using Formula (5).

The acceleration calculation unit 116 calculates an acceleration A-adj (a first acceleration), which is obtained by adjusting the designated acceleration A with the acceleration adjustment amount adj, for decelerating the present command speed V in the first interpolation cycle (from the time tN to the time tN+T) at the time of starting deceleration. Further, the acceleration calculation unit 116 calculates an acceleration A′ (a second acceleration) for performing deceleration from a command speed V-(A-adj) after performing deceleration at the acceleration A-adj to the corner speed Vc with the remaining number of interpolations (n−1), using Formula (6).

$${A}^{′} = ( V - ( h - a d j ) - Vc ) / ( n - 1 ) \qquad ( 6 )$$

By the pre-interpolation acceleration/deceleration processing unit 110 designating the acceleration in the first interpolation cycle T at the time of starting deceleration, which has been calculated by the acceleration calculation unit 116, as A-adj, the deceleration processing unit 114 performs deceleration from the present command speed V to the command speed V′ (=V-(A-adj)) in the first interpolation cycle T. By the pre-interpolation acceleration/deceleration processing unit 110 designating the acceleration A′ of Formula (6) for the remaining number of interpolations (n−1), the deceleration processing unit 114 performs deceleration from the command speed V-(A-adj) to the corner speed Vc with the remaining number of interpolations (n−1).

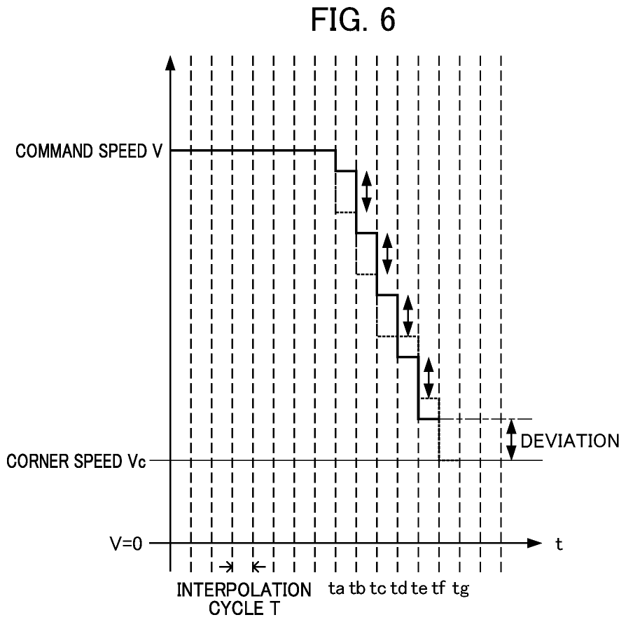

Thereby, the numerical control device 1 can prevent occurrence of a deviation of FIG. 6 without performing the temporary discontinuation of deceleration of FIG. 5.

The interpolation processing unit 120 performs interpolation processing for the path of the spindle of the machine tool (not shown), a tool or the like for each interpolation cycle T, for example, based on the machine program and a command speed from the pre-interpolation acceleration/deceleration processing unit 110.

The drive shaft control unit 130 performs control of a drive shaft included in the machine tool (not shown), for example, based on a result of the interpolation processing by the interpolation processing unit 120.

### <Acceleration Correction Process of Numerical Control Device 1>

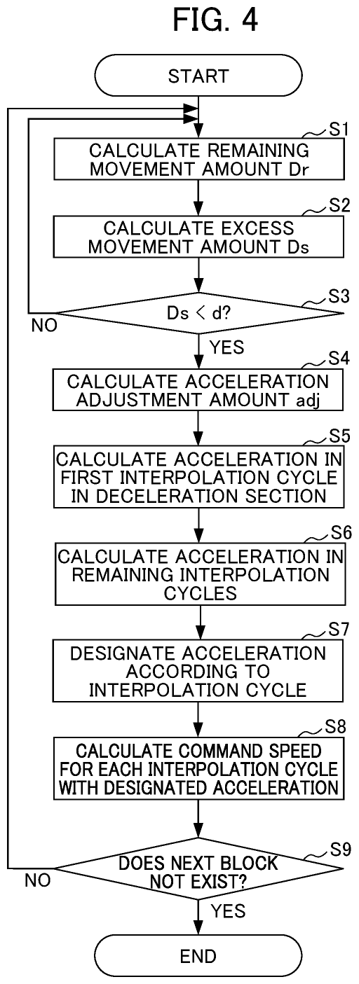

Next, a flow of an acceleration correction process of the numerical control device 1 will be described with reference to FIG. 4.

FIG. 4 is a flowchart illustrating the acceleration correction process of the numerical control device 1. The flow shown here is repeatedly executed each time the machining program is executed.

At Step S1, the remaining movement amount calculation unit 111 calculates the remaining movement amount Dr by adding up movement amounts buffered for the interpolation cycles T, respectively, using Formula (2).

At Step S2, the excess movement amount calculation unit 112 calculates the excess movement amount Ds using the remaining movement amount Dr of the block calculated at Step S1, Formula (3), and Formula (4).

At Step S3, the deceleration processing execution unit 113 judges whether the excess movement amount Ds calculated at Step S2 is smaller than the movement amount d for each interpolation cycle T or not. If the excess movement amount Ds is smaller than the movement amount d, the process proceeds to Step S4. On the other hand, if the excess movement amount Ds is equal to or larger than the movement amount d for each interpolation cycle, the deceleration processing execution unit 113 maintains the present command speed V, and the process proceeds to Step S1.

At Step S4, the adjustment amount calculation unit 115 calculates the acceleration adjustment amount adj using Formula (5).

At Step S5, the acceleration calculation unit 116 calculates the acceleration A-adj, which is obtained by adjusting the designated acceleration A with the acceleration adjustment amount adj, for decelerating the present command speed V in the first interpolation cycle T at the time of starting deceleration.

At Step S6, the acceleration calculation unit 116 calculates the acceleration A′ for performing deceleration from the command speed V-(A-adj) after performing deceleration at the acceleration A-adj to the corner speed Vc with the remaining number of interpolations (n−1), using Formula (6).

At Step S7, the pre-interpolation acceleration/deceleration processing unit 110 designates an acceleration according to each interpolation cycle in the deceleration section.

At Step S8, the deceleration processing unit 114 calculates a command speed for each interpolation cycle in the deceleration section with the acceleration designated at Step S7.

At Step S9, the pre-interpolation acceleration/deceleration processing unit 110 judges whether the next block of the machining program exists or not. If the next block exists, the process returns to Step S1. On the other hand, if the next block does not exist, the acceleration correction process of the numerical control device 1 ends.

As described above, the numerical control device 1 according to the one embodiment calculates the acceleration adjustment amount adj at the time of starting deceleration for using all the excess movement amount Ds with the number of interpolations n in the deceleration section for performing deceleration from the present command speed V to the corner speed Vc, based on the excess movement amount Ds, the present command speed V, the corner speed Vc, and the designated acceleration A, and calculates the acceleration A-adj, which is obtained by adjusting the designated acceleration A with the acceleration adjustment amount adj, for decelerating the present command speed V in the first interpolation cycle at the time of starting deceleration. Further, the numerical control device 1 calculates the acceleration A′ for performing deceleration from the command speed V-(A-adj) after performing deceleration at the acceleration A-adj to the corner speed Vc with the remaining number of interpolations (n−1). Thereby, the numerical control device 1 can perform deceleration without a deviation with respect to a corner speed while keeping behavior during the deceleration constant.

Then, the numerical control device 1 can reduce impact on the drive system of the machine tool (not shown) by the behavior being constant, and can make it easy to adjust the drive system because there is no deviation. Further, the numerical control device 1 can keep the corner speed constant.

One embodiment has been described above. The numerical control device 1, however, is not limited to the embodiment described above, and modifications, improvements, and the like to the extent that the object can be achieved are included.

### Modification Example

Though the numerical control device 1 performs deceleration from the present command speed V to the corner speed Vc in the above embodiment, the numerical control device 1 is not limited thereto. For example, the numerical control device 1 may be applied to the case of performing acceleration from the present command speed V to a predetermined speed Va (Va>V).

Each of the functions included in the numerical control device 1 according to the one embodiment can be realized by hardware, software, or a combination thereof. Here, being realized by software means being realized by a computer reading and executing a program.

The program can be saved using various types of non-transitory computer readable media and be supplied to the computer. The non-transitory computer readable media include various types of tangible storage media. Examples of the non-transitory computer readable media include magnetic recording media (e.g., a flexible disk, a magnetic tape, and a hard disk drive), magnetic optical recording media (e.g., a magnetic optical disk), a CD-read only memory (CD-ROM), a CD-R, a CD-R/W, and semiconductor memories (e.g., a mask ROM, a programmable ROM (PROM), an erasable PROM (EPROM), a flash ROM, and a RAM). The program may be supplied to the computer by means of various types of transitory computer readable media. Examples of the transitory computer readable media include an electric signal, an optical signal, and an electromagnetic wave. The transitory computer readable medium can supply the program to the computer via a wired communication path such as an electric wire or an optical fiber or a wireless communication path.

Steps describing the program recorded in a recording medium include not only processes that are performed in time series in the order thereof but also processes that are not necessarily performed in time series but are executed in parallel or individually.

In other words, a numerical control device of the present disclosure can take various kinds of embodiments having the following configurations.

(1) A numerical control device 1 of the present disclosure includes: a remaining movement amount calculation unit 111 configured to calculate a remaining movement amount of a block included in a machining program; an excess movement amount calculation unit 112 configured to calculate, as an excess movement amount, a difference between the remaining movement amount of the block and a movement amount required to perform deceleration from a present command speed to a corner speed at a designated acceleration; an adjustment amount calculation unit 115 configured to calculate, based on the excess movement amount, the present command speed, the corner speed, and the designated acceleration, an acceleration adjustment amount at time of starting the deceleration, for using all the excess movement amount with the number of interpolations in a deceleration section for performing the deceleration from the present command speed to the corner speed; an acceleration calculation unit 116 configured to calculate a first acceleration obtained by adjusting the designated acceleration with the acceleration adjustment amount, for decelerating the present command speed at the time of starting the deceleration, and calculate a second acceleration for performing deceleration from the command speed that has been decelerated at the first acceleration to the corner speed with the remaining number of interpolations; and a pre-interpolation acceleration/deceleration processing unit 110 configured to designate the first acceleration at the time of starting the deceleration and designate the second acceleration for the remaining number of interpolations.

According the numerical control device 1, it is possible to perform deceleration without a deviation with respect to a corner speed while keeping behavior during the deceleration constant.

(2) The numerical control device 1 according to (1) may include: a deceleration processing execution unit 113 configured to execute deceleration processing when the excess movement amount is smaller than a movement amount for each of the interpolation cycles; and a deceleration processing unit 114 configured to be executed by the deceleration processing execution unit 113 to, for each of the interpolation cycles, subtract the first or second acceleration from the present command speed and determine a command speed for a next interpolation cycle.

Thereby, the numerical control device 1 can optimize the timing of performing deceleration processing and the amount of deceleration for each interpolation cycle.

### EXPLANATION OF REFERENCE NUMERALS

1 numerical control device
10 control unit
110 pre-interpolation acceleration/deceleration processing unit
111 remaining movement amount calculation unit
112 excess movement amount calculation unit
113 deceleration processing execution unit
114 deceleration processing unit
115 adjustment amount calculation unit
116 acceleration calculation unit
120 interpolation processing unit
130 drive shaft control unit

1. A numerical control device comprising:
a remaining movement amount calculation unit configured to calculate a remaining movement amount of a block included in a machining program;
an excess movement amount calculation unit configured to calculate, as an excess movement amount, a difference between the remaining movement amount of the block and a movement amount required to perform deceleration from a present command speed to a corner speed at a designated acceleration;
an adjustment amount calculation unit configured to calculate, based on the excess movement amount, the present command speed, the corner speed, and the designated acceleration, an acceleration adjustment amount at time of starting the deceleration, for using all the excess movement amount with the number of interpolations in a deceleration section for performing the deceleration from the present command speed to the corner speed;
an acceleration calculation unit configured to calculate a first acceleration obtained by adjusting the designated acceleration with the acceleration adjustment amount, for decelerating the present command speed at the time of starting the deceleration, and calculate a second acceleration for performing deceleration from the command speed that has been decelerated at the first acceleration to the corner speed with the remaining number of interpolations; and
a pre-interpolation acceleration/deceleration processing unit configured to designate the first acceleration at the time of starting the deceleration and designate the second acceleration for the remaining number of interpolations.

2. The numerical control device according to claim 1, further comprising:
a deceleration processing execution unit configured to execute deceleration processing when the excess movement amount is smaller than a movement amount for each of the interpolation cycles; and
a deceleration processing unit configured to be executed by the deceleration processing execution unit to, for each of the interpolation cycles, subtract the first or second acceleration from the present command speed and determine a command speed for a next interpolation cycle.
